(19) United States
(12) Patent Application Publication
(10) Pub. No.: US 2020/0283177 A1
(43) Pub. Date: Sep. 10, 2020

(54) PROCESS FOR MAKING A CONSUMER GOODS PRODUCT

(71) Applicant: The Procter & Gamble Company, Cincinnati, OH (US)

(72) Inventors: Albert Jan Gerardus ROELEN, Strombeek-Bever (BE); Anton DE GROEVE, Mechelen (BE); Tomas ANDRASCIK, Vossem (BE); Emine DEGIRMENCI PERES PAULUCCI, Brussels (BE); Thomas CHARLIER, Brussels (BE); Ralf BOMBACH, Plan-les-Ouates (CH)

(21) Appl. No.: 16/262,969

(22) Filed: Jan. 31, 2019

(30) Foreign Application Priority Data
Feb. 1, 2018 (EP) 18154772.0

(51) Int. Cl. B65B 31/00; C11D 17/04; B65B 65/00; B65D 65/46

(52) U.S. Cl. CPC B65B 31/00; B65D 65/46; B65B 65/006; C11D 17/042

(57) ABSTRACT

A process for making a consumer goods product, where the consumer goods product has a container and at least one water-soluble unit dose article housed within the container, and where the process has a step of storing the water-soluble unit dose article on an intermediate line.

### FIELD OF THE INVENTION

The present disclosure relates to a process for making a consumer goods product wherein the consumer goods product comprises a container and at least one water-soluble unit dose article housed within the container and wherein the process comprises a step of storing the water-soluble unit dose article on an intermediate line.

### BACKGROUND OF THE INVENTION

Water-soluble unit dose articles are known and liked by consumers. They are efficient and easy to use minimizing spillage and mess in wash operations such as laundry or automatic dish washing. Such water-soluble unit dose articles comprise water-soluble films which define at least one internal chamber that houses a detergent composition. Upon addition to water, the film dissolves releasing the detergent composition into the wash. The water-soluble unit dose articles are sold in containers so a consumer purchases a consumer goods product comprising a container typically housing multiple water-soluble unit dose articles.

Traditionally, manufacture of such a consumer goods product has been a two-step process. Typically, manufacture of the water-soluble unit dose article is followed by packing of the water-soluble unit dose article into the container. This has been done as a single operation in which the manufactured unit dose article is transported straight to a packing operation in which it is added to the container ready for shipping.

However, due to the nature of the water-soluble unit dose articles and the requirements of consumers, such traditional manufacturing processes have posed a number of challenges.

Firstly, since water-soluble unit dose articles are designed to dissolve in water, they are affected by atmospheric conditions during manufacture and storage. For examples, moisture can move across the water-soluble film meaning the water-soluble unit dose article can equilibrate to surrounding conditions. If the atmospheric conditions in the container during transport and storage are such that moisture moves out of the water-soluble unit dose article, this can condense in the container resulting in water droplets that can prematurely locally dissolve the water-soluble film leading to pinholes in the film through which detergent can leak out. Hence, it is preferred that the water-soluble unit dose article are given conditioning time to adjust to atmospheric conditions.

In addition, consumers prefer variability in terms of type (e.g. detergents for coloured clothes versus detergents for white clothes washes) and size (e.g. large size containers preferred for more frequent washes) of the consumer goods product. For example this depends on the type and volume of space they have at home for storing the consumer goods product. Hence, it is preferred to be able to quickly and easily change the packing line to allow for filling of different types of containers. Additionally, whatever solution is provided to allow for quick and easy changeover of the packing line must minimise damage, including premature rupture, of the water-soluble unit dose article. On a manufacture or packing line, premature rupture can quickly cause contamination of surrounding water-soluble unit dose articles and result in lost production time due to clean-up operations.

Furthermore, there is a desire to minimise the number of processing steps and complication to the manufacturing process. Excessive steps usually entails further apparatus/machinery which can affect environmental conditions in the manufacturing facility, cause unwanted accidental damage to water-soluble unit dose articles or simply increase manufacturing costs etc.

In addition, known production processes can be inefficient. This is because the manufacturing line and packing lines are reliant on one another in terms of production throughput. For example, if the packing line is packing small containers, the rate of throughput will be lower than larger containers, as there will be more full containers per time interval when smaller and hence more time used in terms of changing to an empty container. This means, the rate of the manufacturing line may need to be slowed to prevent excess water-soluble unit dose articles from being produced and so ‘clogging’ the line since packing is operating at a slower rate.

Therefore, there is a need for a process of manufacturing a consumer goods product comprising a water-soluble unit dose article, that allows for the conditioning of the water-soluble unit dose article after it is made and allows for flexibility in the packing of the water-soluble unit dose article whilst minimizing process complexity.

It was surprisingly found that the process according to the present invention overcame this technical problem.

Without wishing to be bound by theory, the process of the present invention includes an intermediate storage step. This allows for conditioning of the water-soluble unit dose article ahead of packing. The intermediate storage step also minimises excess packaging lines needed since the manufacturing lines and packing lines are decoupled from one another, allowing water-soluble unit dose articles from any particular manufacturing line to be transferred to any particular packing line. Hence dedicated packing line(s) per manufacturing line are not needed. This improves the efficiency of production, as the manufacturing and packing lines are not dependent on one another in terms of production speed. This means rate of production on the manufacturing and packing lines can be maximized and the production process overall optimized. In addition, such a step of having a storage line minimises risk of accidental premature rupture of the water-soluble unit dose article as compared to other processes for redirecting water-soluble unit dose articles from one packing line to an alternative packing line.

### SUMMARY OF THE INVENTION

The present disclosure relates to a process for making a consumer goods product wherein the consumer goods product comprises a container and at least one water-soluble unit dose article housed within the container, the process comprising the steps of:
a. making the at least one water-soluble unit dose article on at least one manufacturing line, wherein said at least one water-soluble unit dose article comprises at least one water-soluble film enclosing a detergent composition;
b. transferring the at least one water-soluble unit dose article from the at least one manufacturing line onto an intermediate line;
c. transporting the at least one water-soluble unit dose article along the intermediate line;
d. transferring the at least one water-soluble unit dose article from the intermediate line onto at least one packing line, wherein the at least one water-soluble unit dose article is transported along the at least one packing line and transferred into the container;
wherein the at least one water-soluble unit dose article is stored on the intermediate line for up to 3 months ahead of being transferred from the intermediate line onto the at least one packing line.

### BRIEF DESCRIPTION OF THE DRAWINGS

FIG. 1 discloses a schematic of the process according to the present invention.

FIG. 2 discloses the schematic of FIG. 1 but wherein the first conveyer and second conveyer have been replaced with a first lift mechanism and second lift mechanism.

FIG. 3 discloses the schematic of FIG. 2 but where the process comprises multiple manufacturing lines and multiple packing lines.

FIG. 4 discloses the schematic of FIG. 3 in which the storage area is located in a different location.

FIG. 5 discloses a water-soluble unit dose article according to the present invention.

FIG. 6 discloses a flow chart showing steps according to the present invention.

FIG. 7 discloses the schematic of FIG. 3 in which the water-soluble unit dose articles in receptacles are manually transferred from the intermediate line to the packing line.

### DETAILED DESCRIPTION OF THE INVENTION

### The Process

The present disclosure relates to a process for making a consumer goods product. A consumer goods product is a product sold to consumers to meet a consumer need. The consumer goods product can be sold ‘as is’, in other words the consumer goods product is the item that the consumer picks up from the shelf. Alternatively, the consumer goods product could be housed as one unit of a multi-component product. For example, more than one consumer goods product could be housed within an outer package and the multiple packaged consumer goods products sold together in a single purchase.

The consumer goods product comprises a container and a water-soluble unit dose article housed within the container. The water-soluble unit dose article is described in more detail below.

The container is described in more detail below. The consumer product may comprise aesthetic elements, for example shrink sleeves or labels attached to the container. Alternatively, the container may be coloured or printed with aesthetic elements or informative print such as usage instructions.

The process comprises the steps of:
a. making at least one water-soluble unit dose article on at least one manufacturing line, wherein said water-soluble unit dose article comprises at least one water-soluble film enclosing a detergent composition.

The water-soluble unit dose article, the water-soluble film and detergent composition are described in more detail below.

Those skilled in the art will be aware of methods to make the at least one water-soluble unit dose article on the at least one manufacturing line. Those skilled in the art will be aware of what is a manufacturing line and suitable manufacturing lines. A manufacturing line is understood to mean a location in which at least one process step is conducted in order to make the water-soluble unit dose article. The manufacturing line could be an automated manufacturing process, such as a conveyer belt, a series of conveyer belts or likewise in which a series of automated sequences are conducted to make the unit dose article. Alternatively, the manufacturing line may be a manual manufacturing line, in which the one or more sequences or steps during making of the water-soluble unit dose article are conducted manually. Most preferably the manufacturing line is an automated manufacturing line. The manufacturing line does not need to be a single entity, for example a single apparatus, rather it can be a series of apparatuses or equipment to achieve the goal of making a water-soluble unit dose article.

The making of the at least one water-soluble unit dose article on the at least one manufacturing line may be a continuous process. Alternatively, the making of the at least one water-soluble unit dose article on the at least one manufacturing line may be an intermittent or batch process.

An exemplary method for making a water-soluble unit dose article on a manufacturing line is to shape a first water-soluble film in a mould to create an open compartment. Fill said compartment with a detergent composition, then close the filled compartment with a second water-soluble film and seal the first and second films together. Alternatively, the filled compartment may be closed by at least one further pre-prepared filled fully enclosed compartment, such that a superposed pouch comprising at least one compartment superposed on top of a first compartment, is created. The films may be sealed via solvent sealing, heat sealing or a mixture thereof. Preferably, the process comprises at least two, preferably at least three, more preferably at least four, even more preferably at least five manufacturing lines, wherein each manufacturing line makes water-soluble unit dose articles. Therefore, multiple water-soluble unit dose articles may be produced simultaneously across multiple manufacturing lines.
b. Transferring the at least one water-soluble unit dose article from the at least one manufacturing line onto an intermediate line.

The intermediate line is described in more detail below. Those skilled in the art will be aware of suitable means to transfer the water-soluble unit dose article from the at least one manufacturing line to the intermediate line. The transfer from the at least one manufacturing line to the intermediate storage line may be via an automated operation, a manual operation or a mixture thereof, preferably an automated operation. A manual operation may involve a person manually lifting the water-soluble unit dose articles from the manufacturing line to the intermediate line. An automated operation may comprise the transfer via a conveyer belt, a lift mechanism or a mixture thereof. Alternatively, the water-soluble unit dose articles may be transferred from the manufacturing line to the intermediate line by falling under the influence of gravity. For example, the end of the manufacturing line is position a distance above the intermediate line and the water-soluble unit dose articles drop off the end of the manufacturing line onto the intermediate line.

Preferably, the manufacturing line and the intermediate line may be positioned aside to one another to allow transfer of the water-soluble unit dose article once it is manufactured directly onto the intermediate line. Alternatively, the manufacturing line and intermediate line may be positioned a distance apart in which the water-soluble unit dose article once manufactured is transported from the manufacturing line to the intermediate line. For example, the intermediate line may be positioned at a different location to the manufacturing line in the same manufacturing facility or may be positioned in a different facility to that of the manufacturing line and which is geographically separated from the manufacturing line.

Preferably the process comprises one intermediate line.

Transfer of the water-soluble unit dose article from the manufacturing line to the intermediate line may be via a continuous process. Alternatively, transfer of the water-soluble unit dose article from the manufacturing line to the intermediate line may be via an indexed (stop/start) process.
c. Transporting the at least one water-soluble unit dose article along the intermediate line.

Those skilled in the art will be aware of suitable means to transport the water-soluble unit dose article along the intermediate line.

Transporting the water-soluble unit dose article along the intermediate line may be achieved via an automated operation, a manual operation or a mixture thereof, preferably via an automated operation.

The intermediate line may comprise a conveyer for transporting the water-soluble unit dose article. Those skilled in the art will be aware of suitable conveyors. Preferred conveyors include Interroll RollerDrive series of conveyers or the Intralox Activated Roller Belt™. Alternative means to transport the water-soluble unit dose articles along the intermediate line include stackers, lifts, series of diverters and mergers. The intermediate line may comprise a conveyer, stackers, lifts, series of diverters and mergers or a mixture thereof.

The conveyor may be a continuous cyclic conveyer preferably having means to allow the water-soluble unit dose article to be moved on or off the cyclic conveyer, e.g. onto the packing line, or into and from a storage area. Alternatively, the conveyer may move in one single direction. Alternatively, the conveyer may be a straight conveyer which can move in only one direction or can move in a first direction and then in the reverse direction.

Alternatively, the intermediate line may not be a completely fixed apparatus, rather comprise a moveable apparatus. Alternatively, the intermediate line comprises both fixed and moveable apparatus.

The water-soluble unit dose article is stored on the intermediate line for up to 3 months ahead of being transferred from the intermediate line onto the at least one packing line. The water-soluble unit dose article may be stored on the intermediate line for between 1 min and 2 months, preferably between 3 min and 1 month. Preferably, the intermediate line comprises means to allow for storage of the water-soluble unit dose article. Preferably, the intermediate line comprises a storage means and a transport means to transport the water-soluble unit dose articles along the intermediate line and to and from the storage means. The storage means may comprise Shuttle or Crane based Automatic Storage Retrieval System, or simple conveyor storage systems or a mixture thereof. The storage area may comprise racks. Alternatively, the storage area may comprise an allotted area on the ground to store the water-soluble unit dose articles.

The water-soluble unit dose articles may be stored separately and individually on the intermediate line. Alternatively, the water-soluble unit dose articles may be stored in one or more receptacles. Preferably, the intermediate line comprises at least two receptacles. Preferably, each receptacle comprises between 1 and 2000, more preferably between 100 and 1500, even more preferably between 200 and 1000 water-soluble unit dose articles.

Those skilled in the art will be aware of an appropriate number of water-soluble unit dose articles to contain within each receptacle. Without wishing to be bound by theory, the skilled person will want to maximize the number of water-soluble unit dose articles in a particular receptacle whilst no putting so many water-soluble unit dose articles in a receptacle that the ones at the bottom of the receptacle are crushed (and hence rupture) from the weight of the water-soluble unit dose articles above them. Those skilled in the art will know how to achieve this.

The process according to the present invention may comprise a means to count the number of water-soluble unit dose articles filled into each receptacle. For example, it may comprise a collection chamber that when full corresponds to a certain number of water-soluble unit dose articles. Once full the collection chamber then empties into the receptacle. The water-soluble unit dose articles may be transferred to the collection chamber via gravity, i.e. it falls off of a conveyer or similar mechanism into the collection chamber and once the collection chamber is full, they are tipped from the collection chamber into the receptacle.

Alternatively, the process may comprise a counting mechanism which allows only a certain volume of water-soluble unit dose articles to pass into a receptacle.

Preferably, the intermediate line comprises a storage means and a transport means to transport the receptacles along the intermediate line and to and from the storage means.

The water-soluble unit dose articles may be transferred into the receptacles directly from the manufacturing line. Alternatively, the water-soluble unit dose articles may be transferred into the receptacle after they have been transferred onto the intermediate line. Alternatively, the water-soluble unit dose articles may be placed in the at least one receptacle on the manufacturing line and then the receptacle transferred from the manufacturing line to the intermediate line. The transfer of the receptacle from the at least one manufacturing line to the intermediate storage line may be via an automated operation, a manual operation or a mixture thereof, preferably an automated operation. A manual operation may involve a person manually lifting the receptacle from the manufacturing line to the intermediate line. An automated operation may comprise the transfer via a conveyer belt, a lift mechanism or a mixture thereof.

In step b, the water-soluble unit dose articles may be transferred via a conveyer that allows the transfer to intermittently stop to allow a filled receptacle to be transported down the intermediate line and an empty receptacle to be moved in place.

The receptacles may be stored in a stacked arrangement.

Preferably, means are provided to prevent foreign objects from entering the receptacles during storage. Also, preferably the environmental conditions within and around the receptacles are controlled during storage of the water-soluble unit dose articles in the receptacles.

The intermediate line may comprise means to clean the receptacles after use, i.e. after they have been emptied. Those skilled in the art will be aware of commercially available apparatus to clean the receptacles. Such apparatus may utilize water or a combination of water and detergent to clean the receptacles. Preferably, the intermediate line comprises means to dry the receptacles once cleaned. Those skilled in the art will be aware of commercially available apparatus to achieve this, for example heating lamps or air drying. The intermediate line may also comprise a means to detect remaining water and/or detergent in the receptacle following drying.

The intermediate line may comprise means to identify ruptured water-soluble unit dose articles on the intermediate line. Those skilled in the art will be aware of suitable devices to achieve this. Such devices could include commercially available 2D or 3D vision systems comprising regular or infra-red cameras. Such devices visually inspect the line and notify the operator when a ruptured water-soluble unit dose article is observed.

The intermediate line may comprise means to identify ruptured water-soluble unit dose articles in the receptacle. Those skilled in the art will be aware of suitable devices to achieve this. Such devices could include commercially available 2D or 3D vision systems comprising regular or infra-red cameras. Such devices visually inspect the receptacle and notify the operator when a ruptured water-soluble unit dose article is observed.

Each receptacle may comprise a unique identifier to allow a control system to transfer the correct water-soluble unit dose articles to the appropriate packing line. The intermediate line, the packing line or both would comprise an appropriate means to read the unique identifier. The unique identify may be a barcode, a radio frequency identification tag (RFID) or a mixture thereof. Alternatively, the receptacle may comprise a sensor that can be tracked via the internet or a closed tracking system.

Each receptacle may contain water-soluble unit dose articles having the same detergent composition. Alternatively, each receptacle may comprise a mixture of water-soluble unit dose articles having different detergent compositions.

Preferably, the process comprises at least two, preferably at least three, more preferably at least four, even more preferably at least five manufacturing lines, wherein each manufacturing line makes water-soluble unit dose articles, and the water-soluble unit dose articles are transferred from the at least two, preferably at least three, more preferably at least four, even more preferably at least five manufacturing lines onto the intermediate line. In other words, multiple manufacturing lines feed water-soluble unit dose articles onto the intermediate line. Preferably, transfer from the at least two, preferably at least three, more preferably at least four, even more preferably at least five manufacturing lines is done simultaneously. Preferably, the process comprises one intermediate line. In other words, multiple manufacturing lines feed water-soluble unit dose articles onto one intermediate line.

Preferably, the water-soluble unit dose article is stored on the intermediate line at;
a. a temperature of between 15° C. and 35° C., preferably between 17° C. and 30° C., more preferably between 18° C. and 27° C.; or even more preferably between 19° C. and 23° C.
b. at a relative humidity of between 10% and 80%, preferably 20% and 50%, more preferably between 23% and 47%, even more preferably between 27% and 43% or most preferably between 30% and 40%.
c. a combination thereof.

Those skilled in the art will be aware of suitable means to measure and control the temperature. Temperature can be controlled using heaters and coolers than are commercially available and known to those skilled in the art. Those skilled in the art will be aware of suitable means to measure and control the relative humidity. A preferred method for measuring the relative humidity is to use a commercially available hydrometer at a temperature between 17° C. and 23° C. Alternatively, the relative humidity may be calculated using humidity and temperature measurements. For example, using a Siemens QFA2060D which measure temperature and humidity. From these measured values, the user can calculate the relative humidity. Relative humidity can be controlled using a commercially available heating, ventilation and air conditioning system (HVAC). Such systems monitor and adjust the properties of the environment in which the process of the present invention is conducted. Such properties include heat, moisture content, oxygen levels or a mixture thereof. The HVAC system comprises commercially available means to remove or add moisture into the environment in which the process of the present invention is conducted.

The at least one water-soluble unit dose article may be maintained at a temperature of between 15° C. and 35° C. preferably between 17° C. and 30° C., more preferably between 18° C. and 27° C., or even more preferably between 19° C. and 23° C. along the entire intermediate line. Alternatively, the water-soluble unit dose article may be maintained at a temperature of between 15° C. and 35° C., preferably between 17° C. and 30° C., more preferably between 18° C. and 27° C.; or even more preferably between 19° C. and 23° C. in one or more parts of the intermediate line. For example, the intermediate line may comprise a storage area and the water-soluble unit dose article may be maintained at a temperature of between 15° C. and 35° C., preferably between 17° C. and 30° C., more preferably between 18° C. and 27° C., or even more preferably between 19° C. and 23° C. in just the storage area.

The at least one water-soluble unit dose article may be maintained at a relative humidity of between 10% and 80%, preferably 20% and 50%, more preferably between 23% and 47%, even more preferably between 27% and 43% or most preferably between 30% and 40% along the entire intermediate line. Alternatively, at least one water-soluble unit dose article may be maintained at a relative humidity of between 10% and 80%, preferably 20% and 50%, more preferably between 23% and 47%, even more preferably between 27% and 43% or most preferably between 30% and 40% in one or more parts of the intermediate line. For example, the intermediate line may comprise a storage area and the water-soluble unit dose article may be maintained at a relative humidity of between 10% and 80%, preferably 20% and 50%, more preferably between 23% and 47%, even more preferably between 27% and 43% or most preferably between 30% and 40% in just the storage area.

The temperature, relative humidity or both may be the same or different to that of the manufacturing line, packing line or both. The intermediate line may be positioned such that the external environment of the intermediate line can be carefully controlled, for example it may be located in a separate room to the manufacturing and/or packing lines. Without wishing to be bound by theory, the process of the present invention allows for conditioning of the water-soluble unit dose article ahead of packing. This reduces the risk of moisture moving out of the water-soluble unit dose article and condensing in the container resulting in water droplets that can prematurely locally dissolve the water-soluble film.

The environmental conditions surrounding the water-soluble unit dose article may be controlled as it is transferred from the conveyer system to the storage area on the intermediate line.
d. Transferring the at least one water-soluble unit dose article from the intermediate line onto at least one packing line, wherein the at least one water-soluble unit dose article is transported along the at least one packing line and transferred into the container. It should be understood that any one individual water-soluble unit dose article is transferred to one packing line only, and not that one water-soluble unit dose article is transferred to more than one packing line.

Those skilled in the art will be aware of suitable means to transfer the water-soluble unit dose article from the intermediate line to the at least one packing line. The transfer from the intermediate line to the at least one packing line may be via an automated operation, a manual operation or a mixture thereof, preferably an automated operation. A manual operation may involve a person manually lifting the water-soluble unit dose articles from the intermediate line to the at least one packing line. An automated operation may comprise the transfer via a conveyer belt, a lift mechanism, diverters and mergers or a mixture thereof. Alternatively, the water-soluble unit dose article may be transferred from the intermediate line to the packing line via gravity. For example, the intermediate line may be positioned a distance above the packing line and the water-soluble unit dose articles falls from the intermediate line onto the packing line.

Preferably, the intermediate line and the packing line may be positioned aside to one another to allow transfer of the water-soluble unit dose article from the intermediate line directly onto the packing line. Alternatively, the intermediate line and packing line may be positioned a distance apart in which the water-soluble unit dose article is transported from the intermediate line to the packing line. For example, the intermediate line may be positioned at a different location to the packing line in the same manufacturing facility, or may be positioned in a different facility to that of the packing line and which is geographically separated from the packing line.

Those skilled in the art will be aware of what is a packing line and suitable packing lines. A packing line is understood to mean a location in which at least one process step is conducted in order to pack the water-soluble unit dose article into the container. The container is described in more detail below. The packing line could be an automated packing process, such as a conveyer belt, a series of conveyer belts or likewise in which a series of automated sequences are conducted to pack the unit dose article. Alternatively, the packing line may be a manual packing line, in which the one or more sequences or steps during packing of the water-soluble unit dose article are conducted manually. Preferably the packing line is an automated packing line. The packing line does not need to be a single entity, for example a single apparatus, rather it can be a series of apparatuses or equipment to achieve the goal of packing a water-soluble unit dose article.

The packing line may comprise a means for collecting water-soluble unit dose articles into a container. For example, it may comprise a collection chamber that when full corresponds to a certain number of water-soluble unit dose articles. Once full the collection chamber then empties into a container. The full container is then removed and a new empty container moved into place. The water-soluble unit dose articles may be transferred to the collection chamber via gravity, i.e. it falls off of a conveyer or similar mechanism on the packing line into the collection chamber and once the collection chamber is full, they are tipped from the collection chamber into the container.

Alternatively, the packing line may comprise a counting mechanism which allows only a certain volume of water-soluble unit dose articles to pass into a container. Transfer from the packing line to the container may be via gravity, in which the water-soluble unit dose articles fall off the end of the packing line into the container.

The packing line may comprise a feeder conveyer from the packing line to the container, wherein said feeder conveyer allows for intermediate stoppage of the feeder conveyer to allow a full container to be removed and an empty container put in its place ahead of the water-soluble unit dose articles continuing to be transported along the feeder conveyer.

Preferably, once the container is filled, a lid is placed on the full open container. The container may then be relocated to a storage area or placed with other containers for shipment. Filled containers may be placed within a secondary packaging for storage and/or shipment. Suitable secondary packaging may include boxes or cartons which are filled with multiple containers. Alternatively, multiple containers may be bound together using shrink sleeves or shrink wrap. Multiple containers may be bound together with shrink sleeves and housed in boxes or cartons. Multiple containers may be placed on pallets for shipping. Said multiple containers on said pallets may be bound together with shrink sleeves, may be housed in boxes or containers or a mixture thereof.

The process preferably comprises at least two, preferably at least three, more preferably at least four, even more preferably at least five packing lines. Therefore, multiple water-soluble unit dose articles may be simultaneously transferred onto multiple packing lines.

Preferably, the process comprises multiple manufacturing lines, multiple packing lines and one intermediate line. The ratio of the number of manufacturing lines to the number of packing lines may be between 3:1 and 1:3, preferably between 1:1.5 and 1:3. The manufacturing line and packing lines may be positioned such that the machine direction of the manufacturing line and the packing lines are the same. The intermediate line may be positioned such that the machine direction is 90° to that of the manufacturing line, packing line or both. Alternatively, the machine direction of the manufacturing lines, the intermediate line and the packing lines may all be the same.

Those skilled in the art will be aware of suitable control systems to control the steps of the process.

Addition substances may be added to the water-soluble unit dose articles between manufacturing and packing. Those skilled in the art will be aware of suitable substances and when and how to make such additions during the present process.

### Water-Soluble Unit Dose Article and Water-Soluble Film

A water-soluble unit dose article is generally in the form of a pouch. It comprises a unitary dose of a composition as a volume sufficient to provide a benefit in an end application. The water-soluble unit dose article comprises at least one water-soluble film shaped such that the unit-dose article comprises at least one internal compartment surrounded by the water-soluble film. The at least one compartment comprises a detergent composition. The water-soluble film is sealed such that the detergent composition does not leak out of the compartment during storage. However, upon addition of the water-soluble unit dose article to water, the water-soluble film dissolves and releases the contents of the internal compartment into the wash liquor.

The film is described in more detail below.

The unit dose article may comprise more than one compartment, even at least two compartments, or even at least three compartments, or even at least four compartments, or even at least five compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

The cleaning composition may be a laundry detergent composition, an automatic dishwashing composition, a hard surface cleaning composition or a combination thereof. The cleaning composition may comprise a solid, a liquid or a mixture thereof. The term liquid includes a gel, a solution, a dispersion, a paste or a mixture thereof.

The unit dose article has a height, a width and a length. The maximum of any of these dimensions is meant to mean the greatest distance between two points on opposite sides of the unit dose article. In other words, the unit dose article may not have straight sides and so may have variable lengths, widths and heights depending on where the measurement is taken. Therefore, the maximum should be measured at any two points that are the furthest apart from each other.

The maximum length may be between 2 cm and 5 cm, or even between 2 cm and 4 cm, or even between 2 cm and 3 cm. The maximum length maybe greater than 2 cm and less than 6 cm

The maximum width may be between 2 cm and 5 cm. The maximum width maybe greater than 3 cm and less than 6 cm.

The maximum height may be between 2 cm and 5 cm. The maximum height maybe greater than 2 cm and less than 4 cm.

These lengths may be in the presence or absence of the flange.

Preferably, the length:height ratio is from 3:1 to 1:1; or the width:height ratio is from 3:1 to 1:1, or even 2.5:1 to 1:1; or the ratio of length to height is from 3:1 to 1:1 and the ratio of width to height is from 3:1 to 1:1, or even 2.5:1 to 1:1, or a combination thereof. These ratios may be in the presence of absence of a flange.

Each individual unit dose article may have a weight of between 10 g and 40 g, or even between 15 g and 35 g.

The film of the present invention is soluble or dispersible in water. Prior to be being formed into a unit dose article, the water-soluble film preferably has a thickness of from 20 to 150 micron, preferably 35 to 125 micron, even more preferably 50 to 110 micron, most preferably about 76 micron.

Preferred film materials are preferably polymeric materials. The film material can, for example, be obtained by casting, blow-moulding, extrusion or blown extrusion of the polymeric material, as known in the art.

Preferably, the water-soluble film comprises polyvinyl alcohol polymer or copolymer, preferably a blend of polyvinylalcohol polymers and/or polyvinylalcohol copolymers, preferably selected from sulphonated and carboxylated anionic polyvinylalcohol copolymers especially carboxylated anionic polyvinylalcohol copolymers, most preferably a blend of a polyvinylalcohol homopolymer and a carboxylated anionic polyvinylalcohol copolymer.

Preferred films are those supplied by Monosol under the trade references M8630, M8900, M8779, M8310.

The film may be opaque, transparent or translucent. The film may comprise a printed area. The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Detergent Composition

The detergent composition may be an automatic dish washing composition, a fabric laundry composition or a mixture thereof.

The detergent composition may be in any suitable form. The detergent composition may be a solid, a liquid or a mixture thereof.

Those skilled in the art will know how to formulate and make a suitable detergent composition using known knowledge and techniques. The detergent composition may comprise common detergent ingredients including surfactants, polymers, bleach, enzymes, perfumes, dyes, structing agents, fillers, water or a mixture thereof.

### Container

The container may be a flexible bag, a rigid tub or a mixture thereof. The container needs to be capable of containing the at least one water-soluble unit dose article. The container may have any suitable size dependent upon the number of water-soluble unit dose articles contained within the container. Each container may comprises between 5 and 100, preferably between 10 and 90, more preferably between 15 and 85 water-soluble unit dose articles.

The container may be of any suitable shape. The container may have an overall straight shape, e.g. with straight sides, or may have a curved shape or may comprise both straight and curved elements. The container may comprise flat surfaces as well as surfaces comprising embossments or other structural element, e.g. designed to improve gripping or structural integrity.

The container may have any suitable shape. Those skilled in the art will be aware of suitable shapes. The container may have a cubic shape, a cylindrical shape, a rectangular shape or a mixture thereof. Whilst the container may have an overall linear shape, for example rectangular, it may comprise curved walls. For example, when viewed from above the container may have rectangular shape, however, when viewed from the front it may comprise convex curved walls curving from the top of the container to the bottom of the container.

The container may be made from any suitable material. The container may be made of natural materials, synthetic materials or a mixture thereof, preferably synthetic materials, more preferably plastic.

The container may be made from plastic materials, metallic materials, paper materials, or a mixture thereof. The container may be made from materials comprising recycled materials.

The container may be made from a plastic material, preferably a polyolefin material. The container may be made from polypropylene, polystyrene, polyethylene, high-density polyethylene, polyethylene terephthalate, polyvinyl chloride, Acrylonitrile Butadiene Styrene, Polycarbonates, Polyamides or a mixture thereof. Preferably, the container may be made from polypropylene, polystyrene, high-density polyethylene, polyethylene terephthalate, or a mixture thereof

The plastic material may have a tensile modulus ranging from 1250 MPa to 3000 MPa, preferably between 1300 MPa and 2300 MPa. Those skilled in the art will know how to measure tensile modulus using techniques commonly known in the art.

The container may be made from metallic materials wherein the metallic material is preferably selected from aluminium, steel or a mixture thereof.

The container may be made from paper materials wherein the paper material is preferably selected from cardboard, laminates, cellulose pulp materials or a mixture thereof.

The material used to make the container may comprise other ingredients, such as colorants, preservatives, plasticisers, UV stabilizers, Oxygen, perfume, recycled materials and moisture barriers or a mixture thereof. The container may comprise areas of external or internal printing.

The container may be made using any suitable process.

Suitable processes include but are not limited to thermoforming, injection molding, injection stretch blow molding, extrusion blowmolding, or a mixture thereof preferably thermoforming or injection molding or a mixture thereof.

Suitable processes include, but or not limited to, tube forming from a flat laminate with a welding step, extruded tube forming, folding or a mixture thereof.

The container may be opaque translucent, or a mixture thereof. Preferably, the container is opaque.

The container may comprise any suitable closure means. The closure means may be a recloseable lid, or a recloseable bag element. The closure means may comprise child deterrent means.

Each container may contain water-soluble unit dose articles having the same detergent composition. Alternatively, each container may comprise a mixture of water-soluble unit dose articles having different detergent compositions.

### EXAMPLES

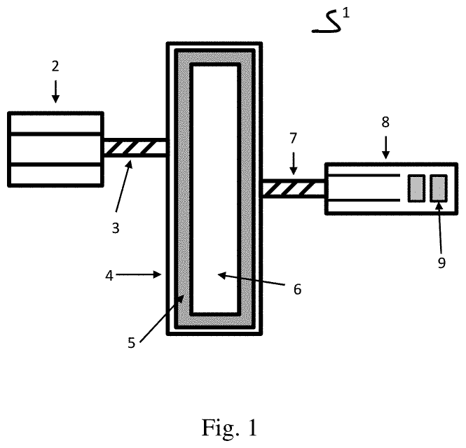

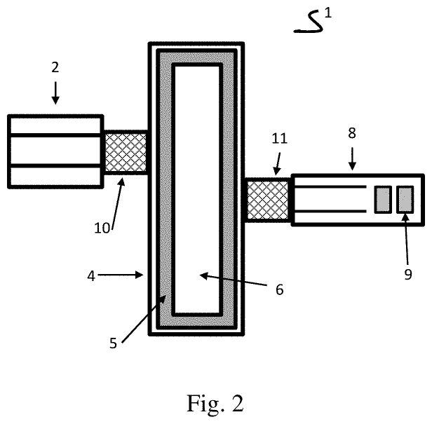

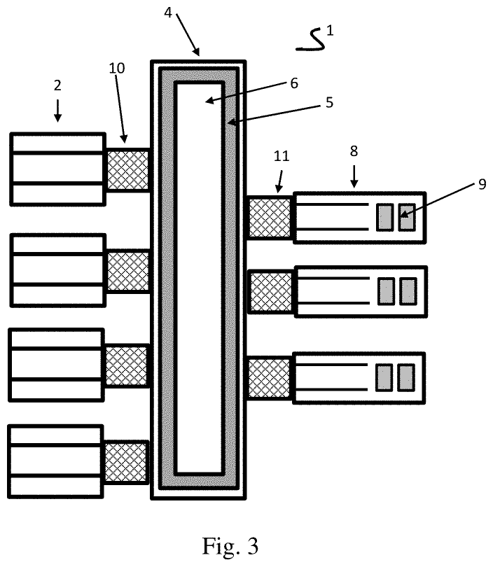

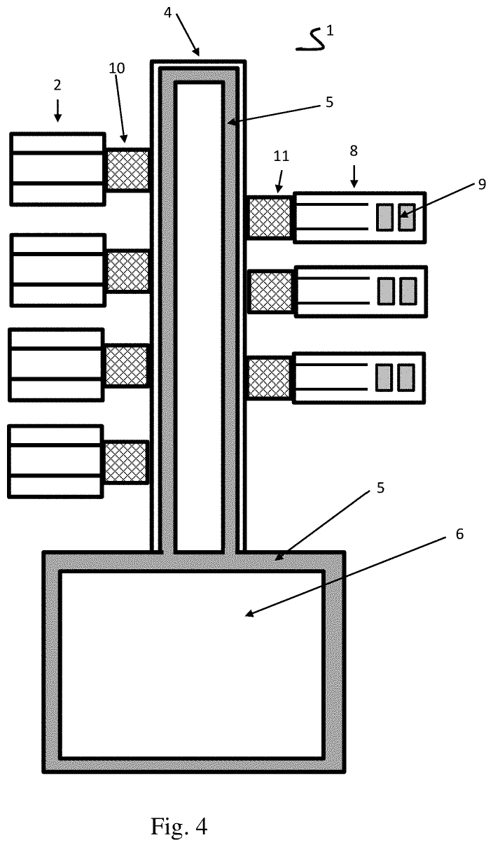

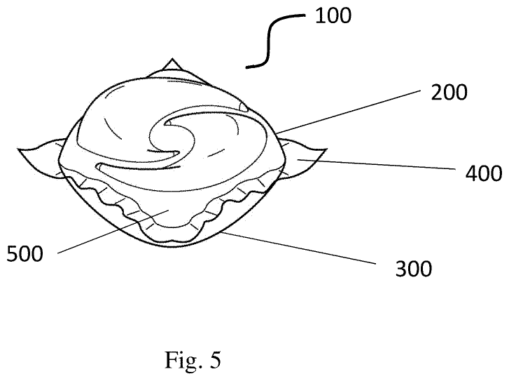

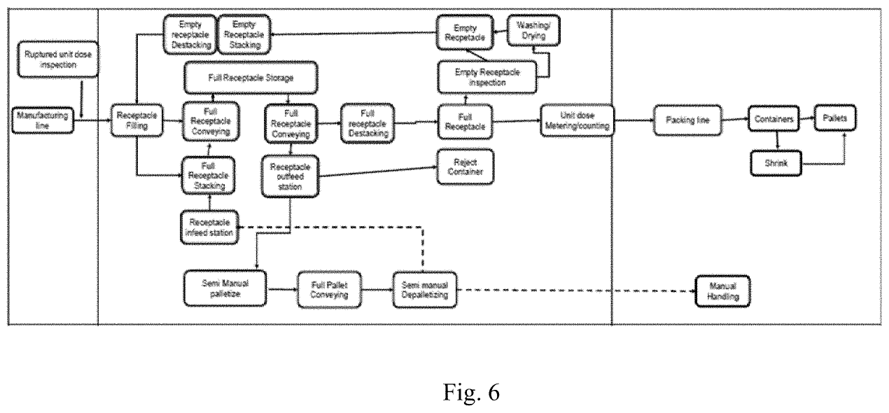

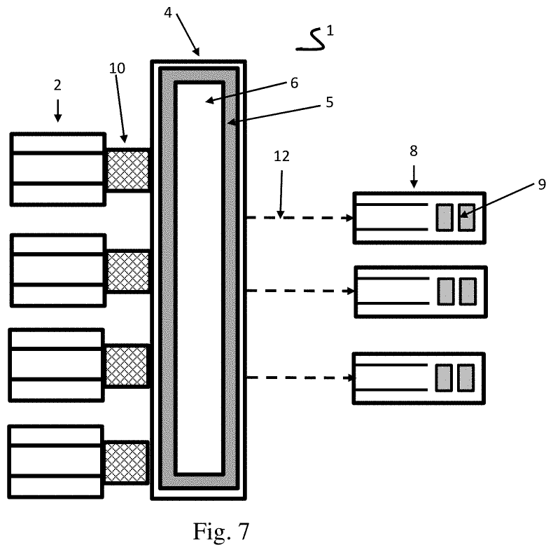

FIG. 1. discloses a schematic of the process according to the present disclosure (1). The at least one water-soluble unit dose article is made on the at least one manufacturing line (2). The water-soluble unit dose article is transferred from the at least one manufacturing line (2) onto the intermediate line (4) via a first conveyer (3). The intermediate line (4) comprises a conveyer (5) and a storage area (6). The intermediate line (4) comprises suitable means to transfer the water-soluble unit dose article from intermediate conveyer (5) to the storage area (6). Alternatively, the water-soluble unit dose article may be stored on the intermediate conveyer (5). The water-soluble unit dose article is transported along the intermediate line (4) and transferred from the intermediate line (4) onto at least one packing line (8) via a second conveyer (7). The water-soluble unit dose article is transported along the at least one packing line (8) and transferred into the container (9).
FIG. 2 discloses the schematic of FIG. 1 but wherein the first conveyer (3) and second conveyer (7) have been replaced with a first lift mechanism (10) and second lift mechanism (11).
FIG. 3 discloses the schematic of FIG. 2 but where the process comprises multiple manufacturing lines (2) and multiple packing lines (8).
FIG. 4 discloses the schematic of FIG. 3 in which the storage area (6) is located in a different location.
FIG. 5 discloses a water-soluble unit dose article (100) according to the present invention. The water-soluble unit dose article (100) comprises a first water-soluble film (200) and a second water-soluble film (300) which are sealed together at a seal region (400). A laundry detergent composition (500) is comprised within the water-soluble soluble unit dose article (100).
   FIG. 6 discloses a flow chart showing steps according to the present invention.
   FIG. 7 discloses the schematic of FIG. 3 in which the water-soluble unit dose articles in receptacles are manually transferred (12) from the intermediate line (4) to the packing line (8).

### Example 1

An exemplary method according to the present invention is as follows in conjunction with any of FIGS. 1-4.

Water-soluble unit dose articles are manufactured on at least one manufacturing line. The water-soluble unit dose articles are transferred from the manufacturing line to an intermediate line, wherein the intermediate line comprises a lifting means to lift the water-soluble unit dose articles from the manufacturing line to the intermediate line.

On the intermediate line the water-soluble unit dose articles are stored for between 1 second and 15 minutes at a temperature of between 5° C. and 35° C. at a relative humidity of between 15% and 50%. The environmental conditions are regulated via conditioned airflow, for example counter flow, cross flow or a mixture.

The water-soluble unit dose articles are then inspected for ruptured water-soluble unit dose articles using UV, light or infra-red detection systems. The water-soluble unit dose articles are then transferred into wash and dried receptacles, each receptacle containing between 1 and 200 water-soluble unit dose articles. Each receptacle has means to track it, for example a bar code.

The receptacle is transported along the intermediate line and stored until required. Once required, the receptacles are transported to a point wherein they are transferred to the packing line. The empty receptacles are then inspected for traces of ruptured water-soluble unit dose articles using UV, light or infra-red detection systems. The receptacles are then washed and dried for re-filling.

The water-soluble unit dose articles are then transported along the packing line and packed into containers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a consumer goods product wherein the consumer goods product comprises a container and at least one water-soluble unit dose article housed within the container, the process comprising the steps of:
a. making the at least one water-soluble unit dose article on at least one manufacturing line, wherein said at least one water-soluble unit dose article comprises at least one water-soluble film enclosing a detergent composition;
b. transferring the at least one water-soluble unit dose article from the at least one manufacturing line onto an intermediate line;
c. transporting the at least one water-soluble unit dose article along the intermediate line;
d. transferring the at least one water-soluble unit dose article from the intermediate line onto at least one packing line, wherein the at least one water-soluble unit dose article is transported along the at least one packing line and transferred into the container;
wherein the at least one water-soluble unit dose article is stored on the intermediate line for up to about 3 months ahead of being transferred from the intermediate line onto the at least one packing line.

2. The process according to claim 1 wherein the water-soluble unit dose article is stored on the intermediate line for between about 1 min and about 2 months.

3. The process according to claim 2 wherein the water-soluble unit dose article is stored on the intermediate line for between about 3 min and about 1 month.

4. The process according to claim 1 wherein the water-soluble unit dose article is stored on the intermediate line at;
a. a temperature of between about 15° C. and about 35° C.;
b. at a relative humidity of between about 10% and about 80%;
c. a combination thereof.

5. The process according to claim 1 comprising at least two manufacturing lines, wherein each manufacturing line makes water-soluble unit dose articles, and the water-soluble unit dose articles are transferred from the at least two onto the intermediate storage line.

6. The process according to claim 5 wherein transfer from the at least two manufacturing lines is done simultaneously.

7. The process according to claim 1 comprising at least two packing lines.

8. The process according to claim 1 wherein the at least one water-soluble unit dose article is stored in a receptacle on the intermediate line and wherein the intermediate line comprises at least two receptacles and wherein each receptacle comprises between about 1 and about 2000 water-soluble unit dose articles.

9. The process according to claim 8 wherein each receptacle comprises a unique identifier.

10. The process according to claim 9 wherein the unique identifier is selected from a barcode, a radio frequency identification tag (RFID) or a mixture thereof.

11. The process according to claim 1 wherein the intermediate line comprises means to identify ruptured water-soluble unit dose articles on the intermediate line.

12. The process according to claim 11 wherein means to identify ruptured water-soluble unit dose articles comprise commercially available 2D or 3D vision systems comprising regular or infra-red cameras.

13. The process according to claim 1 wherein the at least one water-soluble unit dose article is transferred from the at least one manufacturing line to the intermediate storage line via an automated operation, a manual operation or a mixture thereof.

14. The process according to claim 1, wherein the intermediate line comprises means to clean and dry empty receptacles.

15. The process according to claim 1 wherein the at least one water-soluble unit dose article is transferred from the intermediate storage line to the at least one packing line via an automated operation, a manual operation or a mixture thereof.

16. The process according to claim 1 wherein transporting the water-soluble unit dose article along the intermediate line is done via an automated operation, a manual operation or a mixture thereof.

17. The process according to claim 1 wherein the container is a flexible bag, a rigid tub or a mixture thereof.

18. The process according to claim 1 wherein the detergent composition is an automatic dish washing composition, a fabric laundry composition or a mixture thereof.

19. The process according to claim 1 wherein the water-soluble unit dose article comprises a polyvinyl alcohol film.
